(19) United States
(12) Patent Application Publication
(10) Pub. No.: US 2017/0291778 A1
(43) Pub. Date: Oct. 12, 2017

(54) DEVICE AND METHOD FOR STACKING ARTICLES

(71) Applicant: CT PACK S.R.L., Valsamoggia (Bologna) (IT)

(72) Inventors: David ROSIGNOLI, Pontegradella (Ferrara) (IT); Andrea QUERZOLI, Ferrara (IT); Daniele DAVI, Ferrara (IT)

(21) Appl. No.: 15/481,100

(22) Filed: Apr. 6, 2017

(30) Foreign Application Priority Data
Apr. 12, 2016 (IT) 102016000037303

(51) Int. Cl. B65G 57/32

(52) U.S. Cl. CPC B65G 57/32

(57) ABSTRACT

A device for stacking articles includes a feeding conveyor including a plurality of contact elements, each for making contact with a single article to convey it along a conveying path. A first transport surface supports the articles along a first portion of the conveying path. A predetermined number of conveying planes support the articles along a second portion of the conveying path which follows the first portion of the conveying path, including a first conveying plane positioned at a first height; a second conveying plane positioned at a second height different from and higher than the first height; and a movable surface for directing articles, movable between a number of positions equal to the predetermined number of conveying planes, to selectively and alternatively connect the first transport surface with one of the conveying planes.

This application claims priority to Italian Patent Application No. 102016000037303 filed Apr. 12, 2016, the entirety of which is incorporated by reference herein.

### BACKGROUND OF THE INVENTION

This invention relates to a device and a method for stacking articles.

### SUMMARY OF THE INVENTION

Various stacking devices are known which comprise a line for feeding food items (usually of the biscuit type), usually of the type with cleats, and a pair of planes located at different heights.

Problems are encountered with these stacking devices when the infeed rates of the products are particularly, wherein the chute must be moved at a particularly high speed: under these conditions, in particular in the step of moving of the chute downwards, a detachment of the article from the chute is often found which may cause malfunctions of the machine and incorrect stacking.

The aim of this invention is to overcome the above-mentioned drawbacks of the prior art.

More specifically, the aim of this invention is to provide a device for stacking and a method for stacking food items which can operate at particularly high infeed rates.

A further aim of this invention is to provide a device for stacking and a method for stacking which are particularly simple and reliable.

According to the invention, these aims are achieved by a device and by a method for stacking according to this invention which comprises the technical features set out in one or more of the appended claims.

### BRIEF DESCRIPTION OF THE DRAWINGS

The technical features of the invention, with reference to the above aims, are clearly described in the annexed claims and its advantages are more apparent from the detailed description which follows, with reference to the accompanying drawings which illustrate a non-limiting embodiment of the invention and in which:

FIG. 1 is a side view of a first embodiment of the stacking device according to this invention;

FIG. 2 is a scaled-up view of a detail of FIG. 1;

FIG. 3 is a schematic view of a method of actuating the stacking device of FIGS. 1 and 2;

FIG. 4 is a side view of a second embodiment of the stacking device according to this invention;

FIG. 5 is a schematic view of a method of actuating the embodiment of the stacking device of FIG. 4.

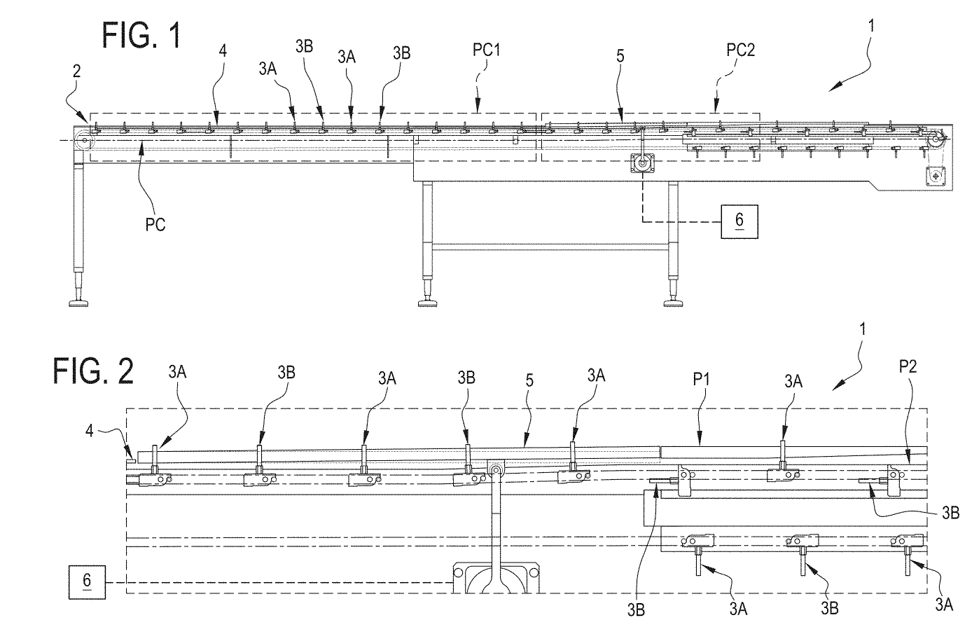

### DESCRIPTION OF THE PREFERRED EMBODIMENTS

With reference to the accompanying drawings, the numeral 1 denotes a device for stacking articles (preferably food items).

The device for stacking articles comprises:

a feeding conveyor 2 equipped with a plurality of contact elements (3A, 3B, 3C), each designed to make contact with a single article A in order to convey it along a conveying path PC;

a first transport surface 4, configured to support the articles A along a first portion PC1 of the conveying path PC;

a predetermined number of conveying planes (P1, P2, P3) for supporting the articles A along a second portion PC2 of the conveying path which follows the first portion PC1 of the conveying path, comprising at least:

a first conveying plane P1 positioned at a first height;

a second conveying plane P2 positioned at a second height, which is different from and higher than the first height;

a movable surface 5 for directing articles A, which is movable at least between a number of positions equal to the predetermined number of conveying planes (P1, P2, P3), to selectively and alternatively connect the first transport surface 4 with one of the conveying planes (P1, P2, P3).

It should be noted that a first portion (3A) of the contact elements (3A, 3B, 3C) is movable between an operating position of making contact with and transporting the articles A, and a non-operating position of disengagement from the articles A adopted at the second portion of the conveying path.

On the other hand, a second portion (3B, 3C) of the contact elements is configured to make contact with and push the contact elements (3A, 3B, 3C) along the above-mentioned first and second portions (P1, P2) of the conveying path.

Preferably, the contact elements comprise cleats.

According to another aspect, the second portion of the contact elements (3A, 3B, 3C) comprises contact elements spaced from each other by a number of contact elements (3A, 3B, 3C) equal to the predetermined number of conveying planes (P1, P2, P3).

In other words, if the number of contact planes is two, the second portion comprises contact elements on every other one, along the conveying direction; vice versa if the number of contact planes is three, the second portion comprises a contact element on every other three, along the conveying direction.

According to another aspect, the method comprises a drive and control unit 6 and an actuator designed to move the movable surface 5 for directing articles A and connected to the drive and control unit 6 to be controlled by it.

According to a first operating method, illustrated in FIG. 2, the drive and control unit 6 is configured to move the movable surface 5 for directing articles A from one conveying plane to another in phase relationship with the feeding conveyor 2, so as to allow feeding a pair of articles A at each feeding plane P1, P2.

As illustrated in FIG. 2, according to this method of operation, the movable surface 5 is positioned in a position in which it connects the first surface 4 with the first conveying plane P1, and transfers a first and a second article (each pushed by a respective contact element), using the movable surface 5, to the first conveying plane P1.

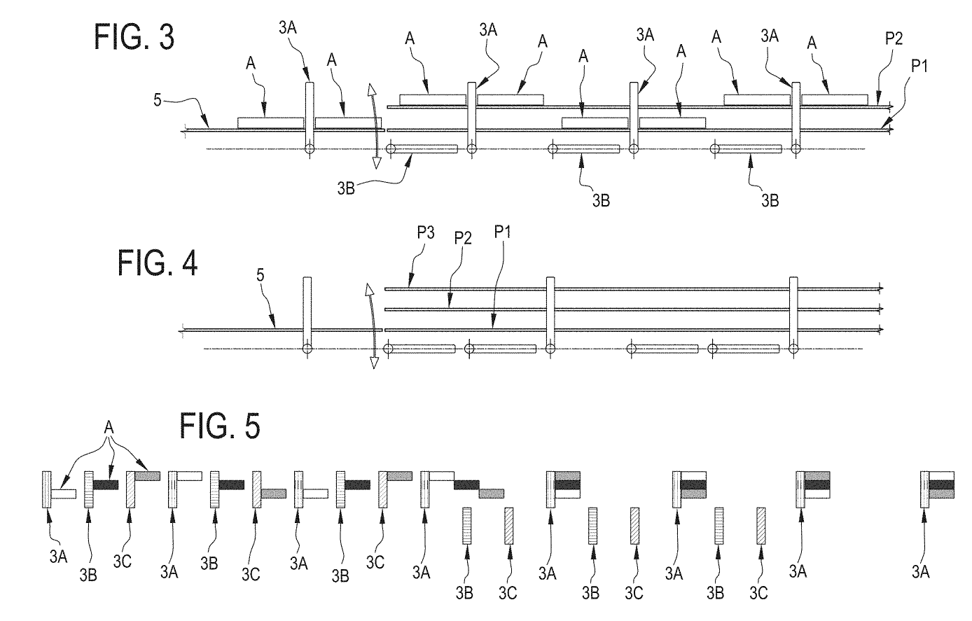

It should be noted that, according to this method, as illustrated in FIG. 3, the first article is pushed by a first contact element, whilst the second article is pushed by a second contact element (after the first).

The second contact element is moved from the operating position to the non-operating position, so as to release the contact with the second article.

It should be noted that, according to this operating method, the movable surface is positioned in a second position connecting the first surface 4 with the second conveying plane P2.

In this condition, a third and a fourth article (each pushed by a respective contact element) is transferred, using the movable surface 5, to the second conveying plane P2.

It should be noted that—with reference to the conveying direction—the third article is next relative to the second article, in the same way as the fourth article is next relative to the third article.

It should be noted that, according to this method, as illustrated in FIG. 3, the third article is pushed by a third contact element (after the second contact element), whilst the fourth article is pushed by a fourth contact element (after the third contact element).

The fourth contact element is moved from the operating position to the non-operating position, so as to release the contact with the fourth article.

It should be noted, on the other hand, that the third contact element pushes the third article, positioned on the second plane P2, and the second article, positioned on the first plane P1. In this way, the third article and the second article are arranged, along the conveying direction, substantially aligned but at different heights.

The stacking by gravity of the article positioned on the second plane P2 on that of the first plane should also be noted, an event originating substantially at the end of the second plane P2.

FIG. 2 illustrated the above-mentioned operating method.

It should be noted that the operating method can be performed with a device 1 for stacking articles provided with any number of conveying planes P: in this case, in effect, only two of the conveying planes P will be used (preferably adjacent to each other in height).

According to another aspect, the conveying planes (P1, P2, P3) further comprise a third conveying plane P3 positioned at a third height, which is different from and higher than the first height and second height.

According to this aspect, the movable surface 5 for directing articles A is movable at least between:

a first connecting position, wherein it connects the first transport surface 4 to the first conveying plane P1,

a second connecting position, wherein it connects the first transport surface 4 to the second conveying plane P2,

a third connecting position, wherein it connects the first transport surface 4 to the third conveying plane P3.

It should be noted that, preferably, the device 1 comprises a drive and control unit 6 and an actuator designed to move the movable surface 5 for directing articles A and connected to the drive and control unit 6 to be controlled by it, the drive and control unit 6 being configured to move the movable surface 5 for directing articles from one conveying plane (P1, P2, P3) to another in phase relationship with the feeding conveyor 2, so as to allow feeding a single article at each feeding plane (P1, P2, P3).

According to the above-mentioned aspect, preferably the drive and control unit 6 is also configured to control the movement of the movable surface 5 according to the following cyclic operating sequence: from the first conveying plane to the second conveying plane, from the second conveying plane to the third conveying plane, from the third conveying plane to the second conveying plane, from the second conveying plane to the first conveying plane.

According to the above-mentioned aspect, the drive unit 6 is configured to control the movement of the movable surface 5 in phase relationship with the feeding conveyor 2 according to the following cyclic operating sequence:

from the first conveying plane to the second conveying plane to release an article onto the second conveying plane P2;

from the second conveying plane to the third conveying plane to release a pair of articles onto the third conveying plane P3;

from the third conveying plane to the second conveying plane to release an article onto the second conveying plane P2;

from the second conveying plane to the first conveying plane to release a pair of articles onto the first conveying plane P1.

According to another aspect, a method is also defined for grouping articles, comprising the following steps:

preparing a grouping device 1 as described above;

feeding articles A using the feeding conveyor 2, with each article A pushed along the first portion P1 of the conveying path P by a contact element (3A, 3B, 3C);

positioning the movable surface 5 for directing articles in a first position of connecting the first transport surface 4 with the first conveying plane P1 to release at least one article A onto the first conveying plane P1 pushed by a first contact element;

positioning the movable surface 5 for directing articles in a second position of connecting the first transport surface 4 with the second conveying plane P2 to release at least one article onto the second conveying plane P2 pushed by a further contact element;

moving one from among the first and the further contact element from the contact position to the disengaged position.

According to a preferred operating method, which can be actuated with a device 1 equipped with two or more pick up planes, the step of positioning the movable surface 5 for directing articles in a first position of connecting the first transport surface 4 with the first conveying plane P1 to release at least one article onto the first conveying plane P1 comprises the following step:

releasing a first article onto the first conveying plane P1, the article being pushed by a first contact element, and a second article pushed by a second contact element which follows the first contact element,

and wherein the step of positioning the movable surface 5 for directing articles in a second position of connecting the first transport surface 4 with the second conveying plane P2 to release at least one article onto the second conveying plane P2 comprises the following step:

releasing a third article onto the second conveying plane P2, the article being pushed by a third contact element which follows the second contact element, and a fourth article pushed by a fourth contact element which follows the third contact element, and further comprising the steps of moving the second and the fourth contact elements from the operating position to the disengaged position.

According to another aspect, the method further comprises the following steps:

preparing a third conveying plane P3 positioned at a third height, which is different from and higher than the first height and second height;

positioning the movable surface 5 for directing articles in a third position of connecting the first transport surface 4 with the third conveying plane P3 to release at least one article onto the third conveying plane P3;

releasing at least one article onto the third conveying plane P3, the article being pushed by a contact element.

According to yet another aspect, the following steps are performed cyclically and in the following order:

positioning the movable surface 5 for directing articles in a first position of connecting the first transport surface 4 with the first conveying plane P1;

releasing a first article A onto the first conveying plane P1, the article being pushed by a first contact element;

releasing a second article A onto the first conveying plane P1, the article being pushed by a second contact element (after the first in the conveying direction);

positioning the movable surface 5 for directing articles in a second position of connecting the first transport surface 4 with the second conveying plane P2;

releasing a third article A onto the second conveying plane P2, the article being pushed by a third contact element (after the first in the conveying direction);

positioning the movable surface 5 for directing articles in a third position of connecting the first transport surface 4 with the third conveying plane P3;

releasing a fourth article A onto the third conveying plane P3, the article being pushed by a fourth contact element (after the first in the conveying direction);

releasing a fifth article A onto the third conveying plane P3, the article being pushed by a fifth contact element.

positioning the movable surface 5 for directing articles in the second position of connecting the first transport surface 4 with the second conveying plane P2;

releasing a sixth article A onto the second conveying plane P2, the article being pushed by a sixth contact element;

positioning the movable surface 5 for directing articles in the first position of connecting the first transport surface 4 with the first conveying plane P1.

According to this aspect, the method also comprises the following steps:

moving the first contact element from the operating position to the non-operating position,

moving the third contact element from the operating position to the non-operating position,

moving the fourth contact element from the operating position to the non-operating position,

moving the sixth contact element from the operating position to the non-operating position.

According to an alternative further aspect, the method comprises the following steps:

moving the second contact element from the operating position to the non-operating position,

moving the third contact element from the operating position to the non-operating position,

moving the fifth contact element from the operating position to the non-operating position,

moving the sixth contact element from the operating position to the non-operating position.

FIG. 5 illustrated the above-mentioned operating sequence.

It should be noted that, advantageously, in this way—according to the sequence described immediately above—it is possible to make a stack of three articles even with particularly high product infeed flows.

In effect, it should be noted that the movable surface 5 moves from one position to another at a speed compatible with the operating requirements of the articles, thanks to the fact that the angular excursion at each movement of the surface 5 is particularly limited.

It should be noted that, in particular during the step of moving the movable surface 5 downwards, the accelerations and the speeds allow the article A to be kept firmly resting on the movable surface 5.

Advantageously, the device 1 described is particularly flexible: it allows stacking of two or more articles in a particularly efficient and safe manner even with high speeds.

The following should be noted with reference to the method of movement of the first portion of the contact elements from the operating position to the non-operating position.

The contact elements of the first portion can be configured to rotate about a point of rotation, from the operating position (vertical, with upper tip upwards) to the non-operating position (horizontal).

More specifically, it should be noted that the contact elements are connected to a transport element (which is part of the feeding conveyor 2) extending on a closed path.

Preferably, the transport element is a chain.

Preferably, the feeding conveyor 2 is equipped with guides, designed to support at least the first portion of the contact elements at the first portion of the conveying path (where there is the first transport surface 4).

It should be noted that the absence of guides at the second portion of the conveying path means that where there are conveying planes (P1, P2, P3) the transport elements of the first portion, which are no longer supported, are moved from the operating position to the non-operating position.

More specifically, as described, the transport elements of the first portion, which are no longer supported, rotate from the operating position to the non-operating position.

What is claimed is:

1. A device for stacking articles, comprising:
a feeding conveyor equipped with a plurality of contact elements, each designed to make contact with a single article in order to convey it along a conveying path;
a first transport surface, configured to support the articles along a first portion of the conveying path;
a predetermined number of conveying planes for supporting the articles along a second portion of the conveying path which follows the first portion of the conveying path, comprising at least:
a first conveying plane positioned at a first height;
a second conveying plane positioned at a second height, which is different from and higher than the first height;
a movable surface for directing articles, which is movable at least between a number of positions equal to the predetermined number of conveying planes, to selectively and alternatively connect the first transport surface with one of the conveying planes,
a first portion of the contact elements being movable between an operating position of making contact with and transporting the articles, and a non-operating position of disengagement from the articles adopted at the second portion of the conveying path, and a second portion of the contact elements being configured to make contact with and push the articles along the above-mentioned first and second portions of the conveying path.

2. The device according to claim 1, wherein the second portion of the contact elements comprises contact elements spaced from each other by a number of contact elements equal to the predetermined number of conveying planes.

3. The device according to claim 2, comprising a drive and control unit and an actuator designed to move the movable surface for directing articles and connected to the drive and control unit to be controlled by it, the drive and control unit being configured to move the movable surface for directing articles from one conveying plane to another in phase relationship with the feeding conveyor, so as to allow feeding a pair of articles at each feeding plane.

4. The device according to claim 3, wherein the conveying planes further comprise a third conveying plane positioned at a third height, which is different from and higher than the first height and second height, and wherein the movable surface for directing articles is movable at least between:
a first connecting position, wherein it connects the first transport surface to the first conveying plane,
a second connecting position, wherein it connects the first transport surface to the second conveying plane,
a third connecting position, wherein it connects the first transport surface to the third conveying plane.

5. The device according to claim 4, comprising a drive and control unit and an actuator designed to move the movable surface for directing articles and connected to the drive and control unit to be controlled by it, the drive and control unit being configured to move the movable surface for directing articles from one conveying plane to another in phase relationship with the feeding conveyor, so as to allow feeding at least a single article at each feeding plane, and also being configured to control the movement of the movable surface according to the following cyclic operating sequence: from the first conveying plane to the second conveying plane, from the second conveying plane to the third conveying plane, from the third conveying plane to the second conveying plane, from the second conveying plane to the first conveying plane.

6. The device according to claim 5, wherein the drive unit is configured to control the movement of the movable surface in phase relationship with the feeding conveyor according to the following cyclic operating sequence:
from the first conveying plane to the second conveying plane to release an article onto the second conveying plane;
from the second conveying plane to the third conveying plane to release a pair of articles onto the third conveying plane;
from the third conveying plane to the second conveying plane to release an article onto the second conveying plane;
from the second conveying plane to the first conveying plane to release a pair of articles onto the first conveying plane.

7. A method for grouping articles, comprising the following steps:
preparing a grouping device according to claim 1;
feeding articles using the feeding conveyor, with each article pushed along the first portion of the conveying path by a contact element;
positioning the movable surface for directing articles in a first position of connecting the first transport surface with the first conveying plane to release at least one article onto the first conveying plane pushed by a first contact element;
positioning the movable surface for directing articles in a second position of connecting the first transport surface with the second conveying plane to release at least one article onto the second conveying plane pushed by a further contact element;
moving one from among the first and the further contact element from the contact position to the disengaged position.

8. The method according to claim 7, wherein the step of positioning the movable surface for directing articles in a first position of connecting the first transport surface with the first conveying plane to release at least one article onto the first conveying plane comprises the following step:
releasing a first article onto the first conveying plane, the article being pushed by a first contact element, and a second article pushed by a second contact element which follows the first contact element,
and wherein the step of positioning the movable surface for directing articles in a second position of connecting the first transport surface with the second conveying plane to release at least one article onto the second conveying plane comprises the following step:
releasing a third article onto the second conveying plane, the article being pushed by a third contact element which follows the second contact element, and a fourth article pushed by a fourth contact element which follows the third contact element, and further comprising the steps of moving the second and the fourth contact elements from the operating position to the disengaged position.

9. The method according to claim 7, further comprising the following steps:
preparing a third conveying plane positioned at a third height, which is different from and higher than the first height and second height;
positioning the movable surface for directing articles in a third position of connecting the first transport surface with the third conveying plane to release at least one article onto the third conveying plane;
releasing at least one article onto the third conveying plane, the article being pushed by a contact element.

10. The method according to claim 9, wherein the following steps are performed cyclically and in the following order:
positioning the movable surface for directing articles in a first position of connecting the first transport surface with the first conveying plane;
releasing a first article onto the first conveying plane, the article being pushed by a first contact element;
releasing a second article onto the first conveying plane, the article being pushed by a second contact element;
positioning the movable surface for directing articles in a second position of connecting the first transport surface with the second conveying plane;
releasing a third article onto the second conveying plane, the article being pushed by a third contact element;
positioning the movable surface for directing articles in a third position of connecting the first transport surface with the third conveying plane;
releasing a fourth article onto the third conveying plane, the article being pushed by a fourth contact element;
releasing a fifth article onto the third conveying plane, the article being pushed by a fifth contact element.
positioning the movable surface for directing articles in the second position of connecting the first transport surface with the second conveying plane;
releasing a sixth article onto the second conveying plane, the article being pushed by a sixth contact element;
positioning the movable surface for directing articles in the first position of connecting the first transport surface with the first conveying plane, and wherein the method also comprises the following steps:
moving the first contact element from the operating position to the non-operating position,
moving the third contact element from the operating position to the non-operating position,
moving the fourth contact element from the operating position to the non-operating position,
moving the sixth contact element from the operating position to the non-operating position.
